(19) United States
(12) Patent Application Publication
(10) Pub. No.: US 2013/0132594 A1
(43) Pub. Date: May 23, 2013

(54) CONTROL OF PARAMETER NEGOTIATION FOR COMMUNICATION CONNECTION

(71) Applicants: Adam Boeszoermenyi, Zurndorf (AT); Robert Ruzitschka, Wien (AT)

(72) Inventors: Adam Boeszoermenyi, Zurndorf (AT); Robert Ruzitschka, Wien (AT)

(73) Assignee: NOKIA SIEMENS NETWORKS OY, Espoo (FI)

(21) Appl. No.: 13/698,290

(22) PCT Filed: May 21, 2010
(86) PCT No.: PCT/EP2010/057067

§ 371 Date: Feb. 4, 2013

(51) Int. Cl. H04L 29/06

(52) U.S. Cl. CPC H04L 65/1066
USPC 709/228

(57) ABSTRACT

The invention relates to a session control entity, method and a computer program product for transmitting a request comprising a parameter relating to setup of media transmission path for a user, and including or detecting in the request an indication indicating whether or not the parameter has been received from the user.

### TECHNICAL FIELD OF THE INVENTION

The present invention relates to a mechanism for controlling a parameter negotiation in a communication connection. In particular, the present invention is related to a method and apparatus for controlling a parameter negotiation in a communication connection, in particular, controlling a media transmission path of a session.

### BACKGROUND OF THE INVENTION

In the last years, an increasing extension of communication networks, e.g. of wire based communication networks, such as the Integrated Services Digital Network (ISDN), or wireless communication networks, such as the cdma2000 (code division multiple access) system, cellular 3rd generation (3G) communication networks like the Universal Mobile Telecommunications System (UMTS), cellular 2nd generation (2G) communication networks like the Global System for Mobile communications (GSM), the General Packet Radio System (GPRS), the Enhanced Data Rates for Global Evolutions (EDGE), or other wireless communication system, such as the Wireless Local Area Network (WLAN) or Worldwide Interoperability for Microwave Access (WiMax), took place all over the world. Various organizations, such as the 3rd Generation Partnership Project (3GPP), Telecoms & Internet converged Services & Protocols for Advanced Networks (TISPAN), the International Telecommunication Union (ITU), 3rd Generation Partnership Project 2 (3GPP2), Internet Engineering Task Force (IETF), the IEEE (Institute of Electrical and Electronics Engineers), the WiMax Forum and the like are working on standards for telecommunication network and access environments.

Within the IP (Internet Protocol) Multimedia Subsystem (IMS) as defined by 3^{rd} Generation Partnership Project (3GPP) Session Initiation Protocol (SIP) defined by Internet Engineering Task Force (IETF) is used for controlling communication. SIP is an application-layer control protocol for creating, modifying, and terminating sessions with one or more participants. These sessions may include Internet multimedia conferences, Internet telephone calls, and multimedia distribution. Members in a session can communicate via multicast or via a mesh of unicast relations, or a combination of these. Session Description Protocol (SDP) is a protocol which conveys information about media streams in multimedia sessions to allow the recipients of a session description to participate in the session. The SDP offers and answers can be carried in SIP messages. Diameter protocol has been defined by IETF and is intended to provide an Authentication, Authorization and Accounting (AAA) framework for applications such as network access or IP mobility.

Generally, for properly establishing and handling a communication connection between network elements such as a user equipment and another communication equipment or user equipment, a database, a server, etc., one or more intermediate network elements such as control network elements, support nodes, service nodes and interworking elements are involved which may belong to different communication networks.

Session border controllers (SBCs), for instance an interconnection border control functions (IBCF) or SIP application level gateway (SIP-ALG) within a proxy call state control function (P-CSCF), are frequently deployed at network borders between IMS networks and towards access networks or enterprise networks attached to an IMS. Such SBC frequently insert gateways into the user plane path, for instance a transition gateway (TrGW) or boarder gateway (BGW), for various purposes such as IP address and port translation and network protection. As an unfortunate side effect, the user plane is forced to traverse the same networks as the signalling plane even if much shorter user plane paths would be otherwise possible, for instance if caller and callee are located in the same visited or enterprise network, but the signalling involved still needs to traverse their home IMS networks. The purpose of optimised media routeing (OMR) is to remove unnecessary gateways from the user plane path.

### SUMMARY OF THE INVENTION

The present invention overcomes the above problem by providing a session control entity, a method and a computer program product for
transmitting a request comprising a pa-rameter relating to setup of media transmission path for a user, and including in the request an indication indicating whether or not the parameter has been re-ceived from the user.

The parameter relating to the setup of media transmission path can be a codec. The indication indicating whether or not the parameter has been received from the user can be one of:
an indication that the parameter has been included by the user,
an indication that the parameter has been included by a communication network, or,
an indication that the parameter has been included by the session control entity.

The indication can be coded as an a-line of a session description protocol.

The session control entity, method and computer program product can further comprise including the parameter in the request.

Further, a session control entity, a method and a computer program product are provided, for
receiving a request comprising a parameter relating to setup of media transmission path for a user,
detecting in the request an indication indicating whether or not the parameter has been re-ceived from the user, and
deciding on handling of the request based on the indication.

The handling of the request can be at least one of:
deciding if transcoding of the media is done locally or not,
removing the parameter from the request, if the indication indicates that the parameter has not been received from the user,
deciding on media release,
deciding on enforcing local policy.

Embodiment of the present invention may have one or more of following advantages:
Network element in a signaling path can become aware of origin of a media parameter and thereby can make better decisions to optimize the media.
Avoid or minimize the number of transcodings on the media path.

### DESCRIPTION OF DRAWINGS

FIGS. 1a and 1b illustrate network architecture and control and user plane paths relevant for aspects of the invention.

FIGS. 2 and 3 illustrate internal structure and functions of an apparatus implementing aspects of the invention.

FIGS. 4 and 5 illustrate example processes for implementing aspects of the invention.

### DETAILED DESCRIPTION OF THE INVENTION

Different types of network entities and functions exist in the IMS network. Call Session Control Functions (CSCF) implement a session control function in SIP layer. The CSCF can act as Proxy CSCF (P-CSCF), Serving CSCF (S-CSCF) or Interrogating CSCF (I-CSCF). The P-CSCF is the first contact point for the User Equipment (UE) within the IMS; the S-CSCF handles the session states in the network; the I-CSCF is mainly the contact point within an operator's network for all IMS connections destined to a subscriber of that network operator, or a roaming subscriber currently located within that network operator's service area.

The functions performed by the I-CSCF are, for example, assigning an S-CSCF to a user performing a SIP registration and routing SIP requests received from another network towards the S-CSCF. The S-CSCF can perform the session control services for the UE. It maintains a session state as needed by the network operator for support of the services and may be acting as Registrar, i.e. it accepts registration requests and makes its information available through the location server (e.g. HSS). The S-CSCF is the central point to users that are hosted by this S-CSCF. The S-CSCF can provide services to registered and unregistered users when it is assigned to these users. This assignment can be stored in the Home Subscriber Server (HSS).

For example, in case of the IMS, an interworking network element known as Media Gateway Control Function (MGCF) is provided which performs call control protocol conversion. For example, the MGCF is used for call control protocol conversion between Session Initiation Protocol (SIP) and ISDN User Part (ISUP). The interworking network element may control a gateway network element, for example in case of the MGCF, the MGCF controls a Media Gateway (MGW), that provides a user plane interworking between both networks. MGCF and MGW may be separated network elements or may also be combined in a single physical entity.

An interconnection border control functions (IBCF) may be applied between two IP multimedia (IM) core network (CN) subsystems or between an IM CN subsystem and other SIP based multimedia networks based on operator preference. The border control function may act both as an entry point and as an exit point for a network. If it processes a SIP request received from other network it functions as an entry point, and it acts as an exit point whenever it processes a SIP request sent to other network.

The functionalities of a border control function can include:
network configuration hiding
acting as application level gateway (ALG)
transport plane control, i.e. QoS control
screening of SIP signaling, including omitting or modifying a received SIP header field prior to forwarding SIP messages
inclusion of an interworking function (IWF) if appropriate; and
media transcoding control in order to allow establishing communication between IM CN subsystems using different media codecs based on the interworking agreement and session information

The functionalities performed by the IBCF can be configured by the operator, and can be network specific.

SIP application layer gateway (SIP-ALG) is an application layer gateway that processes the Session Initiation Protocol (SIP) signalling, can control the media proxy through a control interface, and can rewrite the Session Description Protocol (SDP) signalling to correspond to the network address translation of the media packets in the media proxy. Media proxy (MP) is a network element that is located at the border of the IP multimedia sub-system (IMS) with the purpose of helping to forward user plane traffic of IMS calls across different IP networks. A media proxy can provide functions related to the Network Address Translation-Protocol Translation (NAT-PT) for user plane traffic. During forwarding, the media proxy can change the source and destination addresses and ports in the protocol headers and performs the necessary changes, such as checksum calculations.

A multimedia resource function (MRF) is a function which can perform multiparty call and multimedia conferencing functions, and can be responsible for bearer control in case of multiparty or multimedia conference, and can communicate with call state control for service validation for multiparty and multimedia sessions.

SDP is used to negotiate parameters for transmitting media between endpoints, but the SDP does not transmit the media itself, which can be done for example using Real-Time Transport Protocol (RTP).

An SDP session description can includes following session related information: Session name and purpose, time(s) the session is active, media comprising the session, information needed to receive those media (addresses, ports, formats, etc.), information about the bandwidth to be used by the session, contact information for the person responsible for the session.

An SDP session description can includes the following media information: The type of media (video, audio, etc.), used transport protocol (RTP/UDP/IP, H.320, etc.), format of the media (H.261 video, MPEG video, etc.), a remote address for media, a remote transport port for media.

In the SDP, information is presented using ASCII format, as text lines. An SDP session description can consist of a session-level section followed by zero or more media-level sections. The session-level part can start with a “v=” line and can continue to the first media-level section. Each media-level section can start with an “m=” line and can continues to the next media-level section or end of the whole session description.

Session-level values can be default for all media unless overridden by an equivalent media-level value. Some lines in each description can be mandatory (REQUIRED) and some can be optional (OPTIONAL, marked with * below).

Session Description:
v=(protocol version)
o=(originator and session identifier)
s=(session name)
i=* (session information)
u=* (URI of description)
e=* (email address)
p=* (phone number)
c=* (connection information—not required if included in all media)
b=* (zero or more bandwidth information lines)
One or more time descriptions (“t=” and “r=” lines; see below)
z=* (time zone adjustments)
k=* (encryption key)
a=* (zero or more session attribute lines)
Zero or more media descriptions

Time Description:
t=(time the session is active)
r=* (zero or more repeat times)

Media Description, if Present:
m=(media name and transport address)
i=* (media title)
c=* (connection information—optional if included at session level)
b=* (zero or more bandwidth information lines)
k=* (encryption key)
a=* (zero or more media attribute lines)

Attribute mechanism (a-lines, “a=”) is for extending the SDP and tailoring the SDP to particular applications or media. Unknown a-lines can be passed onwards in the network if a network element does not understand the content of the a-line.

Basic system architecture of a communication network may comprise a commonly known architecture of a wired or wireless access network subsystem. Such an architecture comprises one or more access network control units, radio access network elements, access service network gateways or base transceiver stations, with which a user equipment is capable to communicate via one or more channels for transmitting several types of data. The general functions and interconnections of these elements are known to those skilled in the art and described in corresponding specifications so that a detailed description thereof is omitted herein. However, it is to be noted that there are provided several additional network elements and signaling links used for a communication connection or a call between user terminals and/or servers than those described in detail herein below.

Furthermore, the network elements and their functions described herein may be implemented by software, e.g. by a computer program product for a computer, or by hardware. In any case, for executing their respective functions, correspondingly used devices, such as an interworking node or network control element, like an MGCF of an IMS network comprise several means and components (not shown) which are required for control, processing and communication/signaling functionality. Such means may comprise, for example, a processor unit for executing instructions, programs and for processing data, memory means for storing instructions, programs and data, for serving as a work area of the processor and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit (e.g. wired and wireless interface means, an antenna, etc.) and the like.

As part of a session setup, UE can signal media parameters that the UE wishes to use for the session as an SDP body (in SDP offer) in an INVITE request. During the routing process of the INVITE request through the network towards the other endpoint, network elements can manipulate the SDP offer, for example, by adding additional codecs. Network elements in the signaling path which later receive the manipulated SDP offer have no means to distinguish between the codecs which were originally included by the UE in the SDP offer and the codecs which were added by an intermediate network element. Lack of this information can have negative impact on decision making to optimize the media handling, for example, decisions on if transcoding functionality shall be included or if it would be possible to localize the media handling (e.g. media release).

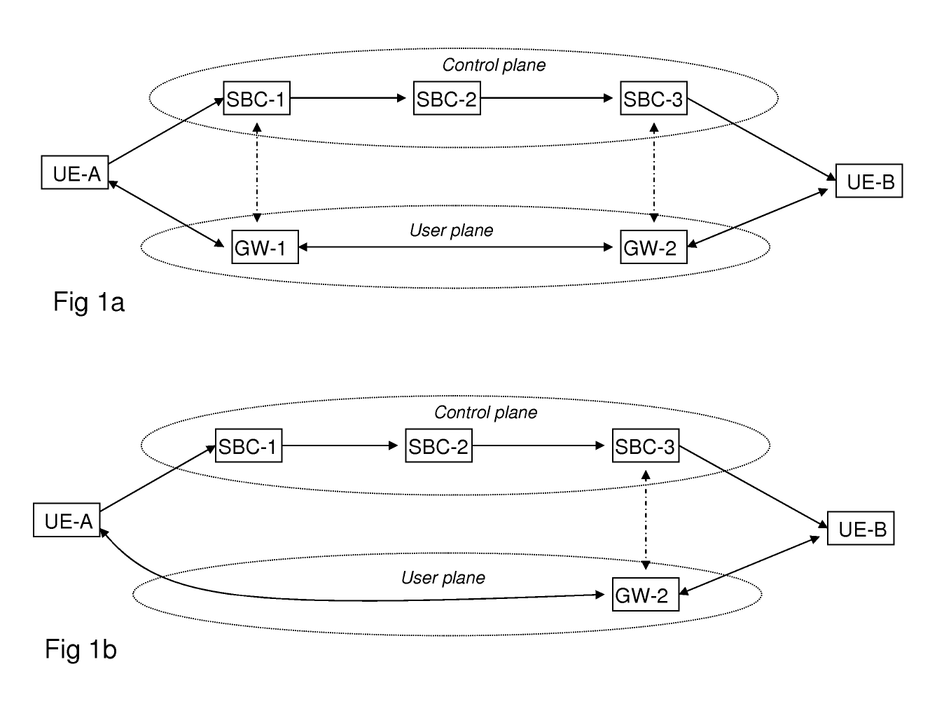

FIG. 1a illustrates how a control plane (e.g SIP signaling) and a user plane (actual user data/media) can be routed between a first user UE-A and a second user UE-B. The control plane can traverse three session control entities, such as SBCs. The SBC-1 can decide to add a user plane gateway GW-1 to the user plane path. In this example the SBC-2 add no gateway to the user plane path, but again the SBC-3 adds a user plane gateway GW-2 to the user plane path. The SBC-1 can control the GW-1 with gateway control signaling as illustrated with dashed arrow between the SBC-1 and GW-1 (and correspondingly between SBC-3 and GW-2). The unidirectional arrows between the control plane elements from UE-A to UE-B illustrate the direction of a session setup, however, signaling messages relating to the session setup can be transmitted to both directions. UE-A is located upstream from the SBCs viewpoint and UE-B is located downstream from the SBCs viewpoint. Bidirectional arrows in the user plane illustrate that user data can be transmitted to both directions between UE-A and UE-B. When each SBC can independently decide about adding GWs in the user plane path, the end result can become non-optimal, since in the final configuration unnecessary GWs may have been added.

According to an aspect of the invention, a network element in a signaling path, such as a CSCF, an IBCF, an MRF or an AS, can mark if certain media related information or parameter in media description, such as a codec, was received from UE and/or can mark if the information was added by the network element.

According to an aspect of the invention, marking can be implemented by adding to the session description protocol (SDP) a specific a-line which can refer to the specific media related information or parameter which was received from the UE or added by the network element. The a-line can refer to media related information or parameter described in m-line of the session description. One or multiple markings can be included in a-line(s), and each a-line can include one or more markings, depending on the implementation.

The SDP offer with codec marking may be sent in an initial INVITE or in a response to an initial INVITE which did not contain an SDP offer.

### EXAMPLE 1

### One Coded Offered by the User

Media line:

m=audio 49120 RTP/AVP 97
(wherein 97 indicates the format number of the offered codec)

A-line:

a=origcodec 97
(“origcodec” is an example text that can be used to indicate that the codec originates from the UE)

### EXAMPLE 2

### One Coded Offered by the Network

Media line:

m=audio 49120 RTP/AVP 97

A-line:

a=transcodec 97
(“transcodec” is an example text that can be used to indicate that the codec has been offered by the network)

### EXAMPLE 3

### Two Codecs. One Coded Offered by the Network, the Other One by the User)

Media line:

m=audio 49120 RTP/AVP 0 97
(wherein 0 and 97 indicates the format numbers of the offered codec)

A-line:

a=transcodec 97

a=origcodec 0

FIG. 1b illustrates more optimal situation compared to FIG. 1a, in which, according to aspects of the invention, the SBC-1 when adding GW-1 to the user plane path (and thereby adding a related codec in the SDP), the SBC-1 can also mark that the codec has been added by the network element. The SBC-3 can detect in the received call setup signaling from the SBC-1 (via SBC-2) that a GW-1 has been added by the network to the user plane path. The detection can be done based on the marking of the codec as described above. The SBC-3 can decide to remove the GW-1 from the user plane path as the SBC-3 can have more knowledge of terminating network and UE-B related properties and can therefore make more optimal decision on needed GWs in the user plane path. The SBC-3 can signal to SBC-1 to remove the GW-1, and the SBC-3 can decide to add its own GW-2 to the user plane path.

According to an aspect of the invention, a signaling message can contain the marking for origin of the codec (from UE/from network) for one, more or all the codecs included in the signaling message.

According to an aspect of the invention, depending on the network configuration, the lack of marking for a codec can be interpreted by a receiving network element in various ways. The lack of marking for certain codec can be interpreted to mean:
1.) No information is available whether the codec in question originates from the UE or has been added by the network.
2.) The codec originates from the UE (for example, if only codecs added by the network are associated with a specific marking)
3.) The codec is added by the network (for example, if only codecs originating from the UE are associated with a specific marking).

Configurations 2.) and 3.) can require that many networks elements support aspects of the invention.

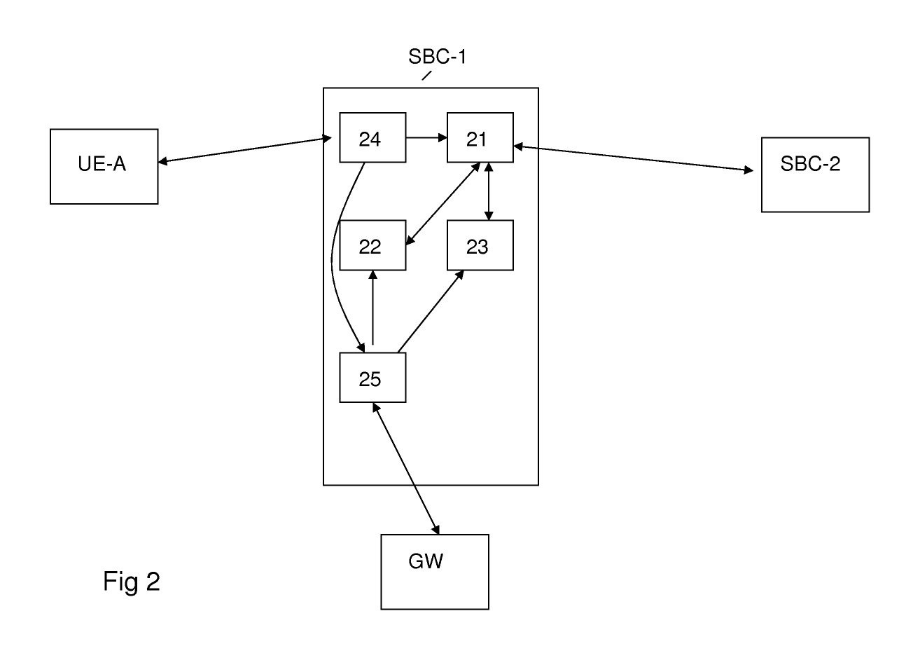

FIG. 2 illustrates example structure and functions of an apparatus implementing aspects of the invention. The apparatus has a transmitting unit 21 configured to transmit a request including a parameter, for example a codec, relating to setup of media transmission path for a user. The request can be a SIP request, such as SIP INVITE. Before transmitting the request by the transmitting unit 21, the request can be received, from a user or from an intermediate network element, by a receiving unit 24. The apparatus can have an including unit 22 configured to include in the request an indication indicating whether or not the parameter has been received from the user, for example, in an SDP a-line.

The apparatus can have a parameter unit 23 configured to include the parameter (e.g. codec) in the request and/or a gateway control unit 25 configured to control a gateway GW which the apparatus can add in the media transmission path. The parameter can relate to properties of the added gateway GW, for example, to media coding according to the coded.

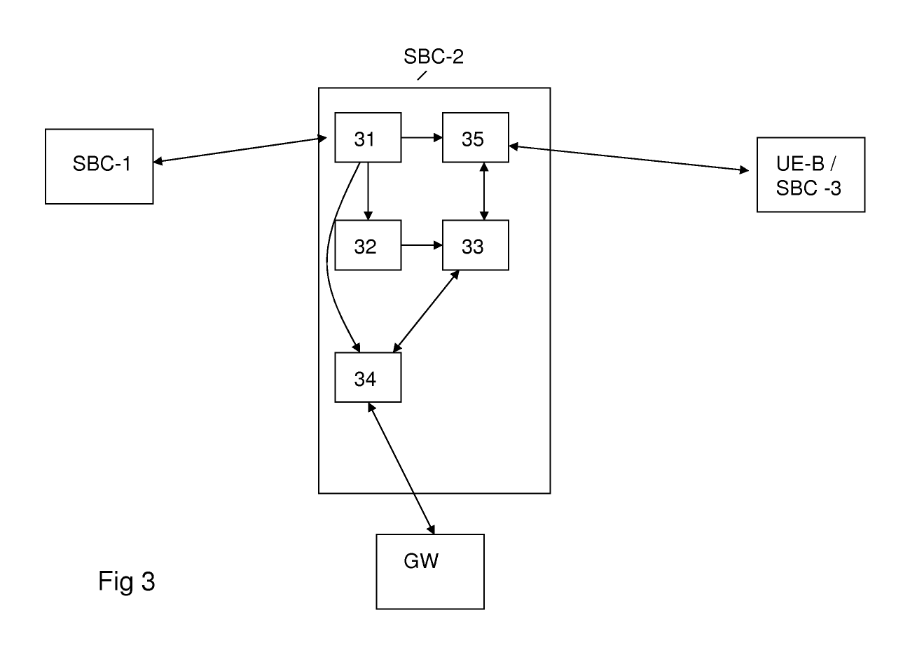

FIG. 3 illustrates example structure and functions of an apparatus implementing aspects of the invention. The apparatus has a receiving unit 31 configured to receive a request, such as SIP INVIRE request, including a parameter (for example a codec) relating to setup of media transmission path for a user. The apparatus can have a detecting unit 32 configured to detect in the request an indication indicating whether or not the parameter has been received from the user. The apparatus can have a deciding unit 33 configured to decide on handling of the request based on the indication, for example, by deciding if transcoding of the media is done locally or not, removing the parameter from the request, if the indication indicates that the parameter has not been received from the user, deciding on media release, or deciding on enforcing local policy.

The apparatus can have a gateway control unit 34 configured to control a gateway GW in a media transmission path and/or a transmitting unit 35 to transmit the request, for example, to another network element or to UE-B.

All units described above may be implemented for example using microprocessors, chips and/or other electrical components and/or by software.

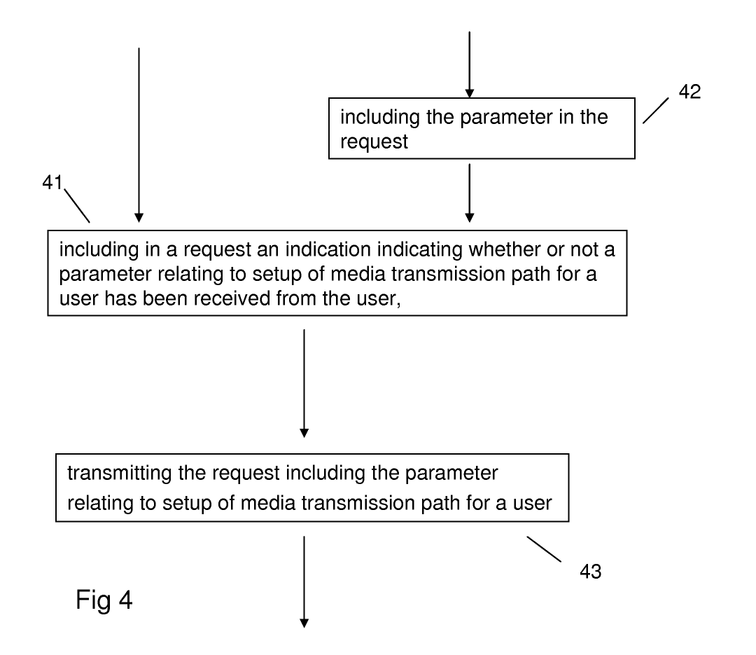

FIG. 4 shows an example process for implementing aspects of the invention. In 41, an indication indicating whether or not a parameter relating to setup of media transmission path for a user, such as a codec, has been received from a user can be included in a request, for example, in a SIP INVITE. The parameter itself can also be included in the request as shown with 42, or the parameter can have already been received from the user or from a previous network element in the request. In 43, the request can be transmitted further in a communication network.

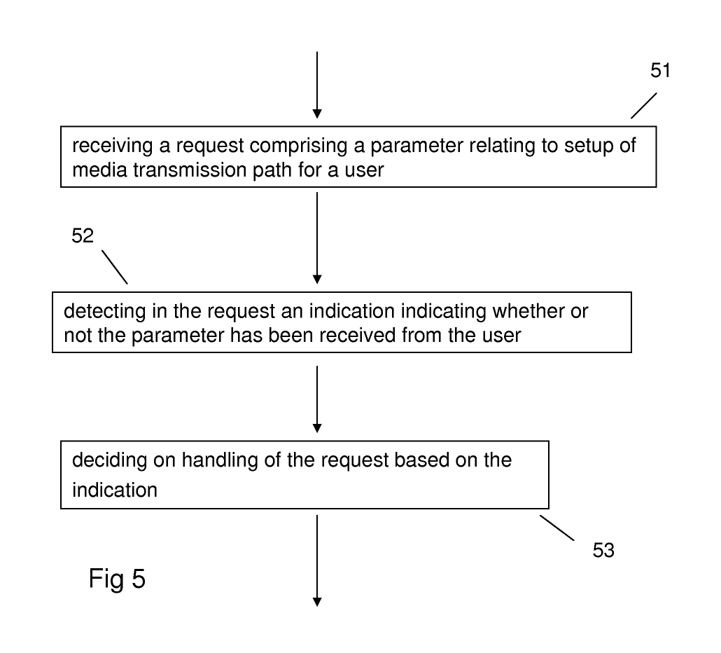

FIG. 5 shows another example process for implementing aspects of the invention. In 51, a request including a parameter relating to setup of media transmission path for a user can be received, for example, in a SIP INVITE request. In 52, an indication can be detected in the request indicating whether or not the parameter has been received from the user, and in 53, handling of the request can be decided based on the indication.

A session control entity may be physically implemented in a switch, router, server or other hardware platform or electronic equipment which can support data transmission and processing tasks, or can be implemented as a component of other existing device.

For the purpose of the present invention as described herein above, it should be noted that
an access technology via which signaling is transferred to and from a network element or node may be any technology by means of which a node can access an access network (e.g. via a base station or generally an access node). Any present or future technology, such as WLAN (Wireless Local Access Network), WiMAX (Worldwide Interoperability for Microwave Access), BlueTooth, Infrared, and the like may be used; although the above technologies are mostly wireless access technologies, e.g. in different radio spectra, access technology in the sense of the present invention implies also wirebound technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,
usable access networks may be any device, apparatus, unit or means by which a station, entity or other user equipment may connect to and/or utilize services offered by the access network; such services include, among others, data and/or (audio-) visual communication, data download etc.;
a user equipment may be any device, apparatus, unit or means by which a system user or subscriber may experience services from an access network, such as a mobile phone, personal digital assistant PDA, or computer;
method steps likely to be implemented as software code portions and being run using a processor at a network element or terminal (as examples of devices, apparatuses and/or modules thereof, or as examples of entities including apparatuses and/or modules therefor), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, apparatuses, units or means likely to be implemented as hardware components at a terminal or network element, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) compo- nents, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

The invention is not limited to codec negotiation in the IMS network(s), but may also be applied in other type of networks having similar kind of session parameter negotiation logic, and possibility to optimize user plane routing. Functions of the session control entity described above may be implemented by code means, as software, and loaded into memory of a computer.

1. A session control entity, comprising
means for transmitting a request comprising a parameter relating to setup of media transmission path for a user,
means for including in the request an indication indicating whether or not the parameter has been received from the user.

2. A session control entity of claim 1, wherein the parameter relating to the setup of media transmission path comprises a codec.

3. A session control entity of claim 1, wherein the indication indicating whether or not the parameter has been received from the user comprises one of:
an indication that the parameter has been included by the user,
an indication that the parameter has been included by a communication network, or,
an indication that the parameter has been included by the session control entity.

4. A session control entity claim 1, wherein the indication comprises an indication coded as an a-line of a session description protocol.

5. A session control entity of claim 1, further comprising means for including the parameter in the request.

6. A session control entity, comprising
means for receiving a request comprising a parameter relating to setup of media transmission path for a user,
means for detecting in the request an indication indicating whether or not the parameter has been received from the user, and
means for deciding on handling of the request based on the indication.

7. A session control entity of claim 6, wherein the handling of the request comprises at least one of:
deciding if transcoding of the media is done locally or not,
removing the parameter from the request, if the indication indicates that the parameter has not been received from the user,
deciding on media release,
deciding on enforcing local policy.

8. A method of controlling media parameters, comprising:
transmitting a request comprising a parameter relating to setup of media transmission path for a user,
including in the request an indication indicating whether or not the parameter has been received from the user.

9. A method of claim 8, wherein the parameter relating to the setup of media transmission path comprises a codec.

10. A method of claim 8, wherein the indication indicating whether or not the parameter has been received from the user comprises one of:
an indication that the parameter has been included by the user,
an indication that the parameter has been included by a communication network, or,
an indication that the parameter has been included by a session control entity.

11. A method of claim 8, wherein the indication comprises an indication coded as an a-line of a session description protocol.

12. A method of claim 8, further comprising including the parameter in the request.

13. A method of controlling media parameters, comprising:
receiving a request comprising a parameter relating to setup of media transmission path for a user,
detecting in the request an indication indicating whether or not the parameter has been received from the user, and
deciding on handling of the request based on the indication.

14. A method of claim 13, wherein the handling of the request comprises at least one of:
deciding if transcoding of the media is done locally or not,
removing the parameter from the request, if the indication indicates that the parameter has not been received from the user,
deciding on media release, - deciding on enforcing local policy.

15. A computer program product comprising code means adapted to produce steps of claim 8 when loaded into the memory of a computer.
